(19) United States
(12) Patent Application Publication
(10) Pub. No.: US 2008/0194821 A1
(43) Pub. Date: Aug. 14, 2008

(54) Light Emitting Compound for Electroluminescent Applications

(75) Inventors: Hans-Hermann Johannes, Braunschweig (DE); Wolfgang Kowalsky, Brauschweig (DE); Sven Ammermann, Braunschweig (DE); Michael Kroener, Braunschweig (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Technische Universitaet Braunchweig, Braunschweig (DE)

(21) Appl. No.: 11/914,046

(22) PCT Filed: May 9, 2006
(86) PCT No.: PCT/EP2005/052090

§ 371 Date: Feb. 21, 2008

(51) Int. Cl. C07F 15/00

(52) U.S. Cl. 546/2; 548/101

(57) ABSTRACT

The present invention refers to light emitting compounds, especially to phosphorescent compounds useful for electroluminescent applications, for example forming a layer in OLEDs and laser applications undoped to emit visible light when excited by electric current. The compounds of the present invention comprise a core structure according to general formula (I), wherein Met=Ir, Pt, Pd, Ru, Rh, Re, or Os with n=1-3, m=3-n for Ir, Ru, Rh, Re or Os and with n=1 or 2, m=2-n for Pt or Pd, wherein r and s are independently positive natural numbers, preferably varying by a maximum of 2, more preferably identical, wherein groups U and V can be selected independently from a chemical bond, any substituted or unsubstituted aromatic or non-aromatic poly- or mono-cyclic group, alkyl, a double bond, a triple bond, nitrogen, oxygen, sulfur, selenium, telluride, NR with R selected from hydrogen, alkyl, aryl or heteroaryl, wherein Ar3 is an aromatic or non-aromatic moiety which allows the formation of chemical bonds to groups U and V, respectively, from neighbouring atoms contained in moiety Ar3, A1 and wherein formula (II) is a saturating ligand.

Light emitting compound for electrooptical applications The present invention refers to light emitting compounds, especially to phosphorescent compounds useful for electrooptical, e.g. electroluminescent applications, for example forming a layer in OLEDs or for laser applications to emit visible light when excited by electric current, as well as to compounds useful in photovoltaic applications.

### STATE OF THE ART

US 2003/0040627 A1 as well as WO 2004/016711 A1 disclose luminescent organometallic compounds complexing the metal atom with chemical bonds, for example six bonds in the case of Ir, two of which formed with each one of three separate organic moieties. In these organic moieties, one bond to the metal atom is formed from a nitrogen atom, the other from a carbon atom, with three chemical bonds and two carbon atoms keeping the nitrogen and carbon atoms apart. The nitrogen and carbon atoms forming bonds to the metal atom are comprised in an aromatic ring each, the aromatic rings are connected to each other by a bond in a positions to the nitrogen atom and the carbon atom, respectively.

### OBJECTS OF THE INVENTION

In view of the previously disclosed organometaric electroluminescent compounds, it is an object of the present invention to provide alternative compounds suitable as light emitters in electrooptical applications.

### GENERAL DESCRIPTION OF THE INVENTION

The present invention achieves the above-mentioned object by providing compounds that form a complex with at least one metal atom, which compounds are suitable as light emitting compounds in electrooptical applications, preferably as triplett emitters.

The compounds of the present invention comprise a core structure according to general formula I

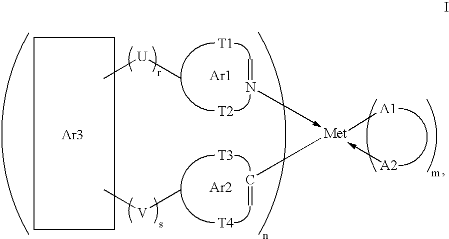

wherein Met=Ir, Pt, Pd, Ru, Rh, Re, or Os

with n=1-3, m=3-n for Ir, Ru, Rh, Re or Os and with n=1 or 2, m=2-n for Pt or Pd,

wherein r and s are independently positive natural numbers from 0 to 8, preferably 1-5, preferably varying by a maximum of 2, more preferably identical,

wherein groups U and V can be selected independently from a chemical bond, any substituted or unsubstituted aromatic or non-aromatic poly- or mono-cyclic group, alkyl, —CR′═CR″—, —C≡C—, nitrogen, oxygen, sulfur, selenium, telluride, NR with R, R′ and R″ independently selected from hydrogen, (hetero)alkyl and (hetero)aryl,

wherein Ar3 is an aromatic or non-aromatic moiety which allows the formation of chemical bonds to groups U and V, respectively, and

wherein T1 to T4 can independently selected from —O—, —S—, —NR—, —CRR′—, ═CR—, ═N—, —N═N—, ═N—, —N═, —NR—O—, —NR—, ═N—S—, —S—N═, —NR—S—, —S—NR—, —N═CR—, —CR═N—, —NR—CR′R″—, —CR′R″—NR—, ═N—CRR—, CRR′—N═, —CR═CR′— with R and R′ and R″ independently selected from hydrogen, (hetero)alkyl, and (hetero)aryl. The substituents R, R′ and R″ can also be connected in a way that a fused ring system results.

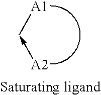

is a monoanionic ligand, preferably selected from the group comprising acteylacetonate or its derivatives, 2-pyridylacetate (also termed picolinate) or its derivatives, dipivaloylmethanate or its derivatives, 2-pyridylformiate or its derivatives, 2-(4H-[1,2,4]triazol-3-yl)pyridine or its derivatives. Saturating ligands of specified and exemplary compounds can be exchanged for one another, even if one specific saturating ligand is indicated.

Compounds of formula I are preferably synthesized from an intermediary μ-chloro-complex. In general, the μ-chloro-complex is represented by the following formula I′, wherein X is a halogen, preferably chlorine.

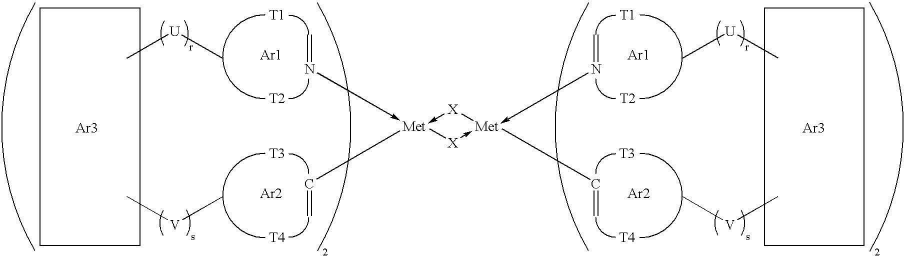

The present invention relates to compounds comprising two anchor-C-atoms in moiety Ar3, each of which form a link to one of groups U and V, carrying Ar1 and Ar2, finally complexing a metal atom to provide for triplett emitter properties. The anchor-C-atoms are essentially arranged within one plane of the moiety Ar3 with their free valence bonds essentially oriented in one direction. The fixation of the anchor-C-atoms within moiety Ar3 serves to provide a fixed backbone structure onto which two moieties, which are independently aromatic or non-aromatic, namely Ar1 and Ar2 can be fixed.

It is preferred that groups U and V as well as moieties Ar1 and Ar2 are n-electron containing systems, preferably creating an affinity between them that leads to a stable arrangement of both moieties Ar1 and Ar2, serving to form a stable fixation of the metal atom to produce an effective and stable triplett emitter.

The group Ar3 can generally be represented by formula II:

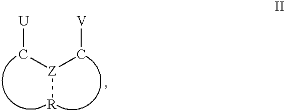

wherein the two carbon atoms are linked to groups U and V, respectively, to form the chemical link with Ar3. Within the context of the invention, these two carbon atoms are termed anchor-C-atoms. In a first embodiment of formula II, Z is a chemical bond directly linking the two anchor-C-atoms. In this embodiment, substituent R completes Ar3 to an aromatic or non-aromatic moiety comprising a five-, six- or seven-membered ring, which may contain hetero atoms (sulfur, preferably nitrogen).

In an alternative second embodiment, Z is an atom or group, preferably an at least threevalent atom, e.g. nitrogen, preferably carbon, or a group comprising from two to four atoms, (e.g. nitrogen, preferably carbon) which connect the two anchor-C-atoms. In this second embodiment, Z needs to be directly linked to an atom forming part of group R, completing Ar3 to a non-aromatic, preferably to an aromatic structure comprising at least two rings, preferably aromatic and/or anellated rings, each of which containing one of the two anchor-C-atoms.

It is the purpose of the two anchor-C-atoms being linked by Z and complemented by R to two rings, to provide for anchor sites of moieties U and V, respectively, and of Ar1 and Ar2, subsequently, which are to be positioned in the vicinity of each other. In the preferred embodiment, the two anchor-C-atoms are comprised in a group Ar3 which is aromatic so that groups Ar1 and Ar2 are oriented essentially coplanar, preferably with an angle between groups Ar1 and Ar2 smaller than 70°, preferably smaller than 65°, more preferably smaller than ±30° or smaller than ±10°. (André Bahl, Dissertation, TU Braunschweig 1998). For illustrative purposes, the angle between Ar1 and Ar2, which are essentially coplanar, is indicated in the following scheme, wherein Ar3 is depicted as a phenyl ring:

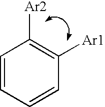

In the first embodiment of general formula II, Z being a chemical bond, lining the two anchor-C-atoms the following structure is obtained:

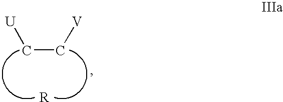

wherein R is a moiety completing Ar3 to a five-, six- or seven-membered ring, preferably aromatic, optionally containing hetero atoms. Examples for structure IIIa are:

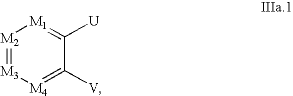

wherein any of M₁ to M₄ can be independently selected from N and CR with R selected from hydrogen, (hetero)alkyl, and (hetero)aryl, and

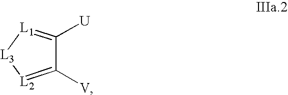

wherein L₃ can be selected from O, S, NR, CRR′, with R and R′ independently selected from hydrogen, (hetero)alkyl, and (hetero)aryl. L₁ and L₂ can be independently selected from N and CR with R independently selected from hydrogen, (hetero)alkyl, and (hetero)aryl.

In a further embodiment of formula II, the following structure IIb can be realised

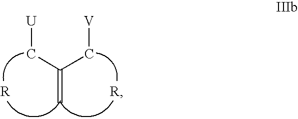

wherein Z is a carbon atom arranged between the two anchor-C-atoms and R is a moiety completing Ar3 to a moiety comprising two aromatic rings, preferably two anellated aromatic rings. These two rings may be five- or six-membered rings, preferably anellated five- and/or six-membered rings. In the embodiment according to formula IIIb, the two anchor-C-atoms are separated by intermediate atom Z (e.g. a carbon atom) and are kept in essentially one plane by group R, preferably forming an aromatic system comprising two rings, each comprising one of the anchor-C-atoms.

More specific embodiments of structure IIIb are the following structures IIIb.1 and IIIb.2:

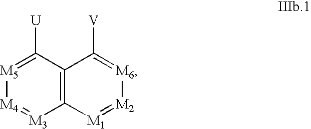

wherein any of M₁ to M₆ can be independently selected from N and CR with R selected from hydrogen, (hetero)alkyl, and (hetero)aryl; and

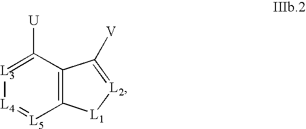

wherein L₁ can be selected from O, S, NR, CRR′ with R and R′ selected from hydrogen, (hetero)alkyl, and (hetero)aryl. Any of L₂-L₅ can independently be selected from N and CR with R selected from hydrogen, (hetero)alkyl, and (hetero)aryl.

In a further embodiment of general formula II, the following structure can be realised:

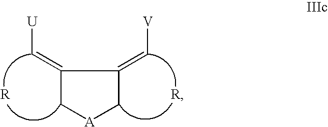

wherein in formula II, Z comprises two carbon atoms. In this embodiment, group R complements Z and the two anchor-C-atoms to a ring system, wherein each of the two anchor-C-atoms is comprised within a five- or six-membered ring, or preferably a five- or six-membered aromatic ring each. These rings, preferably aromatic, are linked to each other by Z and additionally form a four-, five-, six- or seven-membered ring arranged between them. The four- to seven-membered ring structure is arranged between the two rings each of which contains one of the anchor-C-atoms, and is formed including substituent Z. This four-, five-, six- or seven-membered ring between the two rings, each of which comprising one of the anchor-C-atoms, serves to fix the positions of the two anchor-C-atoms essentially in one plane, i.e. the free rotation of the rings comprising the anchor-C-atoms around a single bond contained within Z is prevented by the ring structure formed between them.

Substituent A may represent a chemical bond, an atom or a group, arranging 1, 2 or 3 atoms or groups (sulfur, oxygen, substituted NR, preferably substituted carbon CR′R″ with R, R′ and R″ independently selected from hydrogen, (hetero)alkyl and (hetero)aryl) within the five-, six- or seven-membered ring, respectively. Accordingly, substituent A, when realised as a chemical bond, will form a four-membered ring, which is part of the two rings comprising the anchor-C-atoms. When substituent A is an atom, for example introducing a sulfur atom, it will form a five-membered ring comprising atoms of the two rings, each containing one anchor-C-atom. In a further embodiment, substituent A may be realised as a group comprising two atoms, for example an ethylene group, forming a six-membered ring connecting the two rings comprising the two anchor-C-atoms. Examples for structure IIIc are the following:

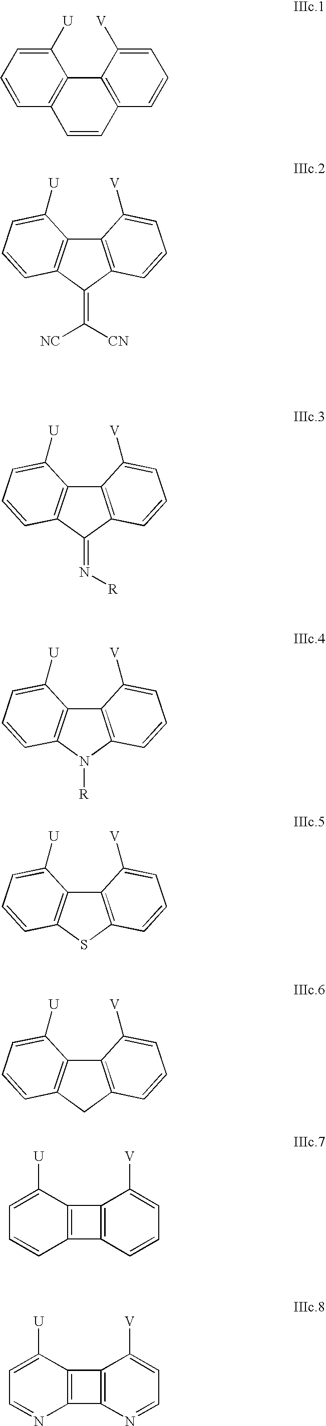

Preferred examples for Ar3, wherein Z is a carbon atom, are two condensed rings, independently selected from five- and six-membered (hetero)aromatic rings, di-substituted with groups U and V at the anchor-C-atoms. Examples for Ar3 are comprised in the group of phenyl, naphthyl, carbazolyl, indazolyl, indolyl, pyridyl, anthryl, phenanthryl, benzamidazolyl, fluorenyl, pyrimidinyl, pyrazinyl, pyridazinyl, quinolinyl, isoquinolinyl, quinoxalinyl, benzothienyl, phthalazinyl, quinazolinyl, imidazolyl, pyrazolinyl, oxazolinyl, oxadiazolinyl, triazolyl, triazinyl, thiadiazolyl, benzimidazolyl, benzoxazolyl, phenanthridinyl, frryl and thienyl, preferably naphtyl, di-substituted in positions 1 and 8, which are the anchor-C-atoms, with groups U and V, respectively.

In a further embodiment, general formula II may be realised as an anthracene moiety or an (hetero-) aromatic compound comprising an anthracene moiety. In this embodiment schematically shown as Ifid below, the two anchor-C-atoms are separated by three carbon atoms, which comprise one carbon atom that has, in contrast to the embodiments according to formulae IIIa to IIIc above, a free valence. However, this embodiment according to IIId is still regarded as an embodiment of the present invention for Ar3, because the anthracene moiety still provides two carbon atoms as anchor-C-atoms in essentially one plane and their free valence bonds essentially directed in parallel.

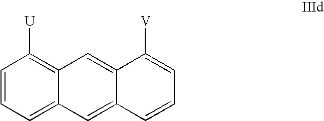

In all of the above formulae, R may carry further substituent groups, i.e. the ring structures comprising one of the two anchor-C-atoms each may carry further substituents. These substituents may be selected from saturated or non-saturated hydrocarbons and may also form condensed aromatic groups with the ring structures, e.g. higher aromatic systems like anthracene, phenanthrene, optionally containing hetero atoms, as well as charge transport moieties.

Further substituents to the structure according to formula II may form higher anellated aromatic groups, e. g. an anthracene moiety, a naphthacene or a pentacene moiety as well as phenanthrene, chrysene, acenaphthylene, pyrene, coronene, benzo(a)pyrene, naphthopyrene or heteroatom substituted homologs thereof, comprising the anchor-C-atoms within portion Ar3 according to one of formulae IIIa-d.

It is preferred that Ar1 comprises a five- or six-membered heteroaryl ring, containing at least one nitrogen atom to bind to the metal atom. Ar1 may e.g. be selected from pyridine, pyrimidine, pyrazine, pyridazine, triazine, tetrazole, indazole, imidazole, pyrazole, oxazole, oxadiazole, thiadiazole and triazole. Ar1 may optionally form part of a fused ring system, that can for example be selected from quinoline, isochinoline, quinoxaline, phthalazine, quinazoline, naphtholidine, cinnoline, phenanthroline, benzimidazole, benzoxazole, benzthiazole, phenazine, pteridine, purine, phenoxazine, phenothiazine, benzo[g]pteridine, indazolyl, indolyl, and phenanthridine.

Ar2 is preferably a five- or six-membered aryl or heteroaryl ring forming a bond from one of its constituent carbon atoms to the metal atom. For example, Ar2 may be phenyl, pyridyl, pyrimidinyl, pyrazinyl, imidazolyl, pyrazolinyl, oxazolinyl, oxadiazolinyl, triazolyl, triazinyl, thiadiazolyl, frryl and thienyl. Ar2 may optionally be part of a fused ring system, e.g. selected from naphthyl, anthryl, phenanthryl, benzamidazolyl, carbazolyl, fluorenyl, pyridazinyl, quinolinyl, isoquinolinyl, quinoxalinyl, benzothienyl, phthalazinyl, quinazolinyl, benzimidazolyl, benzoxazolyl, and phenanthridinyl.

Both Ar1 and Ar2 may further be substituted, for example by halogen atoms, alkyl (comprising one to fifteen carbon atoms), haloalkyl (e.g. CF₃, CF₂CF₃), alkyloxy, aryloxyaryl, alkyloxyaryl, aryl, alkylaryl, cyano, amino, dialkylamino, diarylamino, alkylthio, arylthio, sulfinyl, sulfonyl, aryloxy, alkylarylamino, benzylic alcohol and aldehyde.

The advantageous properties of the inventive compounds are assumed to be caused by the proximity of groups U and V, respectively linked to anchor-C-atoms comprised in Ar3, preferably orienting groups U and V in parallel. This forces substituents Ar1 and Ar2 into close proximity and, preferably, into coplanar orientation, finally resulting in the proximity of the nitrogen atom and the carbon atom which form bonds to the metal atom.

Examples for U and V, which are selected independently, are phenyl, naphthyl, thienyl, pyrrolyl, oxazolyl, and anthracene or phenanthrene.

Substituents to Ar3 are independently selected from hydrogen, (hetero) alkyl and (hetero) aryl, which may form anellated ring systems to Ar3, as well as electron donating or electron accepting substituents like e.g. halogen, —CN, —C═O, —C═NR′R″, and —CHO. Alternatively or in addition, one or more of substituents to Ar3 may be electron transporting or hole transporting substituents and/or emitting substituents and/or dopant substituents and/or so-called auxochromic groups.

Examples for electron transporting groups are 4,7-diphenyl-1,10-phenanthroline (Bphen) and derivatives thereof like 2,9-dimethyl4,7-diphenyl-1,10-phenanthroline (BCP), 2,5-diaryloxadiazoles and derivatives thereof like 2-(p-tert.-butylphenyl)-5-p-biphenyl)-oxadiazole (PBD), oligo-(benzoxadiazol-2yl)-arenes and derivatives thereof like bis-2,5-(5-tert.-butyl-benzoxadizol-2-yl)-thiophene (BBOT), 1,3-bis[5-(Aryl)-1,3,4-oxadiazol-2yl]benzenes and derivatives thereof like 1,3-bis[5-p-tert.-butylphenyl)-1,3,4-oxadiazol-2yl]benzene (OXD-7), 2,5-diaryltriazoles and derivatives thereof like 2-p-tert.-butylphenyl)-5-(p-biphenyl)-triazole (TAZ).

Examples for hole transporting substituent groups are tris-[(N,N-diaryl)amino]-triphenylamines like 4,4′,4″-tris[(N-(1-naphthyl)-N-phenylamninotriphenylamine] (1-TNATA) and its derivatives, 4,4′,4″-tris[(N-(2-naphthyl)-N-phenylamino)-triphenylamine] (2-TNATA) or 4,4′,4″-tris[(N-(3-methylphenyl)-N-phenylamino)-triphenylamine] (m-TDATA) and its derivatives, 4,4′,4″-tris(carbazole-9-yl)triphenylamines; N,N,N′,N′-tetra-arylbenzidines as N,N,N′,N′-tetraphenylbenzidine and its derivatives, N,N′-bis(1-naphthyl)-N,′-diphenylbenzidine (α-NPD), N,N′-di(naphthalene-2-yl)-N,N′-diphenylbenzidine (β-NPD), 4,4′-bis(carbazole-9-yl)biphenyl (CBP) and its derivatives, and their heteroatom substituted analogs (e.g. thienyl-, selenyl-, furanyl-derivatives); 4,4′-bis(2,2′-diphenylvinyl)-1,1′-biphenyl (DPVBI); triarylamines and their derivatives, 4,4′-bis(N,N-diarylamino)-terphenyls, 4,4′-bis(N,N-diarylamino)-quarterphenyls and their homologs and derivatives, N,N′-dinethylchinacridone and its derivatives, 1,1-bis-(4-bis(4-methyl-phenyl)-aminophenyl)-cyclohexane (TPAC) and N,N,N,N′-tertraaryldiaminofluorenes as well as their derivatives;

Examples for emitter materials are derivatives of a known laser dye fnnily as coumarines, rhodamines, merocyanines like DCM, DCM2, or cyanines, or oxonoles, or even another metal-centered species;

Examples for dopant materials are bis(-tetracyanomethylidene)quinone (TCNQ) an its derivatives, bis-2,5-(-tetracyano-methylidene)thiophenes and their derivatives and heteroatom substituted homologues;

auxochromic groups are for example NR′ R″, OR, NO₂, SR, CN, CF₃, SO₂R, SO₃R, COX, (CN)₂C═C(R), (CN)₂C═C(CN)—, with X selected from H, R, OR, SR, wherein R can be selected from hydrogen, (hetero)alkyl or (hetero)aryl.

### Embodiment of the Emitter Compound as an Orthogonally Oriented Compound

In a further embodiment (formula IV below), the emitter compounds of the invention form part of an orthogonally oriented compound. Here, one group Ar3, comprising at least two aromatic or anellated rings, e.g. according to formulae II or IIa-d, independently selected from five- and six-membered (hetero) anellated rings, and a second group Ar3, independently configured, e.g. according to fomulae II or IIIa-d, are each linked to central atom ZA, which has a tetraedric configuration. The linkage to central atom ZA is depicted in formula IV as W1 and W2 or W3 and W4, respectively, which may all be chemical bonds. Preferably, at least one of W1, W2, W3, W4 is an intermediate residue, more preferably, at least one of each of W1, W2 and W3, W4, respectively is an intermediate atom or group, or both of W1, W2 and W3, W4, respectively, are intermediate residues to the linkage between each group Ar3 and the central atom ZA. However, the realization of each W1-W4 as a chemical bond or as an intermediate residue is chosen independently from the realization of the others. In this embodiment, central atom ZA is further substituted with a second group Ar3, for example Ar3 being comprised in a compound according to general formula I or as detailed here, as a naphthyl group, optionally further substituted with differing functional moieties for electrooptical applications, e.g. electron or hole transporting moieties.

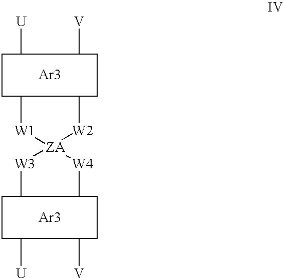

In this embodiment, both groups Ar3 can be naphthyl groups, with carbon atoms 1 and 8 (the anchor-C-atoms) linked to groups U and V, carrying groups Ar1 and Ar2, which in part form the complex to the metal atom; and with carbon atoms 4 and 5 linked to central atom ZA, which linkage may be a direct bond or via an intermediate atom, forming a five-membered or six-membered ring with the central atom ZA, respectively. As a result, at least one emitter compound according to general formula I, as an example, having a naphthyl group as Ar3, is linked to a central tetraedric atom, forming an orthogonally oriented compound with a second group Ar3. The second group Ar3 can be substituted to confer emitter properties as well, or, alternatively, confer differing electroluminescent properties, e.g. charge transport. This embodiment is presented by general formula V for compounds suitable for electroluminescent (EL) applications:

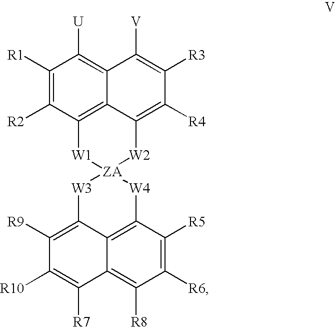

wherein groups Ar3 are both represented by naphthyl groups, but both Ar3 can be realised according to formulae II, IIIa-d above,

wherein W1, W2, W3, W4 can be selected from at least divalent atoms and groups, e.g. —S—, —NR—, —O—, —CH₂—, a carbonyl group, —SO₂—, and di-substituted silicon, —CRR′—, and a chemical bond, with R and R′ independently selected from any (hetero)alkyl or (hetero)aryl or hydrogen,

wherein R1 to R10 are independently selected from (hetero)alkyls, (hetero)aryls, electro-optically functional groups, wherein two or more of R1 to R10 can be condensed arenyl groups and/or non-arenyl groups, and

wherein ZA is selected from carbon, silicon, and germanium. However, two adjacent substituents of R5 to R9 can be U and V, respectively, forming the basis for groups Ar1 and Ar2 to bind a further metal atom as a binuclear triplett emitter.

The structure of formula V comprises a first naphthyl group that forms group Ar3 according to general formula I, and a second opposite naphthyl group that is the second group Ar3, optionally carrying further EL functional moieties, which groups Ar3 are connected via central atom ZA. The naphthyl groups of both groups Ar3 are each linked to the central atom ZA through their anchor-C-atoms and by intermediate residues W1, W2 and W3, W4, respectively, linking the first naphthyl group to central atom ZA and intermediate residues W3, W4 respectively, linking the second naphthyl group to central atom ZA.

Intermediate residues W1, W2, W3 and W4 are selected from a chemical bond, divalent groups and atoms, e.g. —CRR′—, —NR—, —O—, —SO₂—, —CO— with R and R′ selected from hydrogen, (hetero)alkyl or (hetero)aryl. Accordingly, the linkage of the first and second naphthyl groups to central atom ZA is independently formed as a four- membered, a five-membered ring or a six-membered ring comprising the α carbon atoms or the α′ carbon atoms, which are part of the first Ar3 (naphthyl group) and of the second Ar3 (naphthyl group), respectively, the intermediate residues W1 to W4 and central atom ZA.

In a preferred embodiment, one of intermediate residues W1, W2 liking the α carbon atoms of the first Ar3 (naphthyl group) to central atom ZA is an atom, whereas the other intermediate residue W3, W4, respectively, is a chemical bond, directly linking one of both α carbon atoms to the central atom ZA, forming a five-membered ring comprising central atom ZA, one intermediate residue and the α carbon atoms of the first Ar3 (naphthyl group). In an alternative embodiment, both intermediate residues W1, W2 are atoms, same or different, each arranged between one of both α carbon atoms of the first Ar3 (naphthyl group) and central atom ZA, forming a six-membered ring comprising the α carbon atoms of the first Ar3 (naphthyl group), both intermediate residues and central atom ZA.

Independent from the embodiment of the linkage of the first Ar3 (naphthyl group) to the central atom, the opposite second Ar3 (naphthyl group) is linked to the central atom with at least one intermediate residue W1, W2 being an at least divalent atom. In one embodiment, the second Ar3 (naphthyl group) is linked to central atom ZA through its α and α′ carbon atoms with one of intermediate residues W1, W2 being an atom and the other one of W2, W1, respectively, being a chemical bond, forming a five-membered ring between the Ar3 (naphthyl group) and central atom ZA including either intermediate residue W1 or W2. In an alternative embodiment, both intermediate residues W1, W2, respectively, are atoms, each arranged between one of the α′ carbon atoms of the second Ar3 (naphthyl group) and the central atom ZA, forming a six-membered ring.

In a preferred embodiment, one of or both of intermediate residues W1, W2, and W3, W4, respectively, are di-substituted carbon atoms, preferably methylene groups. Alternatively, one of W1, W2 and W3, W4, respectively, is a di-substituted carbon atom, preferably CRR′ with R and R′ independently selected from hydrogen, (hetero)alkyl or (hetero)aryl, whereas the other intermediate residue is sulfur, oxygen or a non-substituted (hydrogen) or mono-substituted nitrogen.

The bonds between each of the Ar3 (naphthyl groups) and the central atom are non-conjugated bonds, providing for electronic isolation of the first and second Ar3 (naphthyl groups). The respective substituents can be linked conjugatedly or non-conjugatedly to their respective Ar3 (naphthyl groups).

The Ar3 (naphthyl groups) of the core structure may form part of higher anellated aromatic moieties, for example the naphthyl moiety may be comprised in an anthracene moiety, a naphthacene or a pentacene moiety as well as in a phenanthrene, chrysene, acenaphthylene, pyrene, coronene, benzo(a)pyrene, or naphthopyrene moiety.

The central structure according to general formula V provides the compounds according to the invention with the advantageous properties of having a low propensity to crystallize, which is reflected in a high glass transition temperature. High glass transition temperatures are desired for compounds in electro-optical applications. It is assumed that the steric confirmation of the central structure, arranging the opposite naphthyl groups in an orthogonally fixed position is the cause for the advantageous properties of preferred compounds according to the invention.

As a further embodiment of the compound according to structure IV, the following compounds VI are realized, wherein substituents U and V are defined as above:

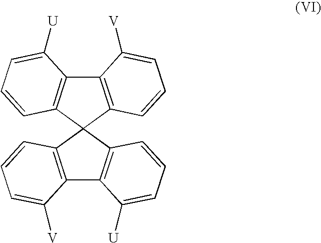

In specific embodiments of compounds comprising emitter structures according to formulae IV to VI, oligomers and polymers are generated, comprising two, three or more substructures according to one or more of formulae IV to VI, with a metal, preferably Ir complexed between two substructures. As an example, a polymer, suitable for coating from solution, is given using substructures according to formula VI, subsequently termed polymer structure VI:

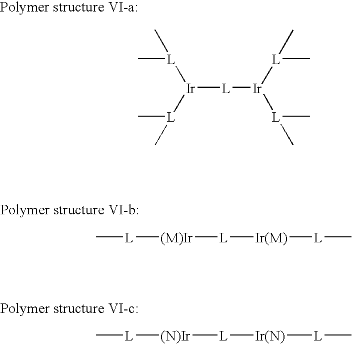

In polymer structures VI-a, VI-b, and VI-c, moieties L, M and N are defined as given below:

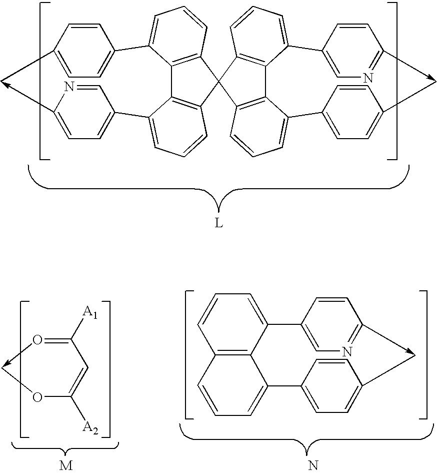

### DETAILED DESCRIPTION OF THE INVENTION

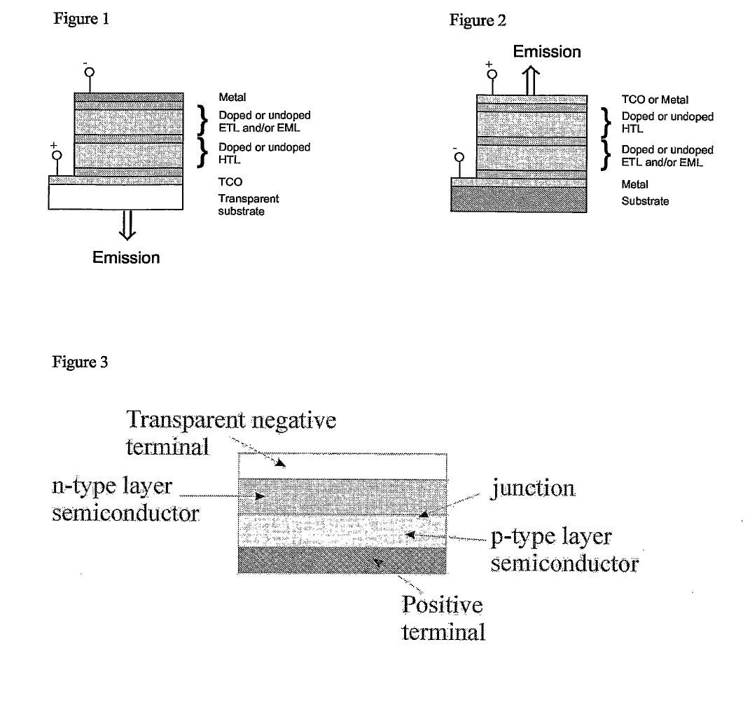

The invention will now be described by means of examples, representing specific embodiments of the compounds according to general formula I. Embodiments of electro-optical devices comprising the compound according to the invention are shown in the Figures, wherein
FIG. 1 schematically depicts an inverted OLED in cross-section,
FIG. 2 schematically depicts an OLED in cross-section, and
FIG. 3 schematically depicts a solar cell in cross-section.

### EXAMPLE 1

### Tris-(3-(8-phenyl-naphthyl)pyridine)-iridium and tris-(4-(8-phenyl-naphthyl)-pyridine)-iridium

Tris-(3-(8-phenyl-naphthyl)-pyridine)-iridium, represented by formula VIIa, shows a compound according to the invention, wherein of general formula I, Ar3 is naphthyl, substituted in each positions 1 and 8 (the anchor-C-atoms) with one of U and V, which are chemical bonds, Ar1 is phenyl and Ar2 is pyridyl having its bond (U) to the naphthyl in its 3′-position.

Derivatives of this compound can be obtained by formally exchanging the naphthyl group for (hetero) aromatic groups comprising at least two anellated rings, which may be five- and/or six-membered rings.

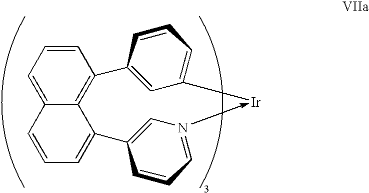

As an isomer of compound VIIa, tris-(4-(8-phenyl-naphthyl)-pyridine)-iridium, is a compound according to the invention and represented by the following formula VIIb. Therein, of general formula I, Ar3 is naphthyl, substituted in each positions 1 and 8 (the anchor-C-atoms) with one of U and V, which are chemical bonds, Ar1 is phenyl and Ar2 is pyridyl having its bond (U) to the naphthyl in its 4′-position.

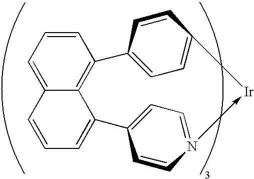

These compounds are suitable for forming an emitter layer of blue light in electroluminescent devices.

Derivatives of compounds VIIa and VIIb can be obtained by formally exchanging at least one of the 1-pyridyl-8-phenylnaphthaline groups for a saturating ligand, e.g. 2-(4H-[1,2,4]triazol-3-yl)pyridine:

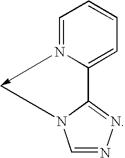

### EXAMPLE 2

### Tris-(3-(2-biphenyl)-pyridine)-iridium

Tris-(3-(2-biphenyl)-pyridine)-iridium, represented by formula VIII, shows a compound according to the invention, wherein of general formula I, Ar3 is phenyl, substituted in each anchor-C-atom (positions 1 and 2) with one of U and V, which are chemical bonds, Ar1 is phenyl and Ar2 is pyridyl having its bond (U) to the phenyl in its 3′-position.

In the alternative to n=3, n can be chosen as 2, complexing the Ir with an acetylacetonate based group instead. This gives di-(3-(8-phenyl-naphthyl)-pyridine)-iridium-(acetylacetonate).

Derivatives of this compound can be obtained by formally exchanging the phenyl group for (hetero)aromatic groups comprising at least one aromatic ring as Ar3, which may be five- or six-membered ring. In accordance with the invention, groups Ar1 and Ar2 are linked to anchor-C-atoms of the aromatic ring Ar3.

Exemplary compounds derivable from formula V are di-(3-(2-biphenyl)-pyridine)-iridium-(acetylacetonate), tris-(3-(4-phenyl-thienyl)-pyridine)-iridium, di-(3-(4-phenyl-thienyl)-pyridine)-iridium-(acetylacetonate), tris-(4-(8-phenyl-naphthyl)-3H-pyrrole)-iridium, di-(4-(8-phenyl-naphthyl)-3H-pyrrole)-iridium-(acetylacetonate), and tris-(5-(8-phenyl-naphthyl)-thiazole)-iridium.

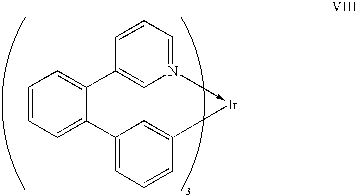

For synthesis of compounds according to the present invention, it is preferred to produce the intermediary μ-chloro-complex, as described in the following for the synthesis of compound VIII.

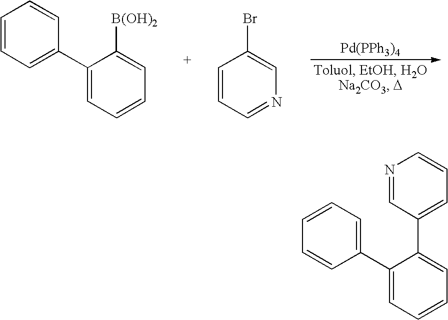

According to the above reaction scheme, one equivalent biphenyl-2-boronic acid, 1.2 equivalents 3-bromopyridine and 3 mole-% tetrakis(triphenylphosphine)-palladium (0) were dissolved in a mixture of 3 L/mole of degassed toluene, 3 L/mole of degassed ethanol and 2 L/mole of degassed water in a round bottom flask under a nitrogen atmosphere. The mixture was stirred for 5 minutes at room temperature. Then, 3 equivalents of sodium carbonate were added to the mixture and the mixture was heated under reflux for 72 hours. Once the reaction mixture was cooled down, it was extracted four times with appropriate portions of CHCl₃, the combined organic fractions were washed twice with appropriate amounts of 1 N solution of sodium hydroxide and twice with appropriate amounts of deionized water. The combined organic fractions were dried over magnesium sulfate and the crude product was flash chromatographed on silica gel (n-hexane:ethyl acetate, 2:1) and recrystallized from n-hexane. White crystals having a melting point of 76° C. were obtained, giving 80.6% yield.

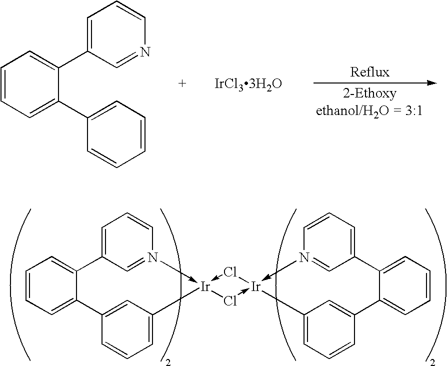

According to the above reaction scheme, di-g-chloro-bis(3-(2-biphenyl)-pyridine-N,C)-iridium(III) was produced.

One equivalent of iridium(III)-chloride-hydrate and 5 equivalents of 3-(2-biphenyl)-pyridine were dissolved in a mixture of 36 L/mole of degassed 2-ethoxyethanol and 12 L/mole of degassed water in a round bottom flask under nitrogen atmosphere. The mixture was heated under reflux for 48 hours. After cooling of the reaction mixture, 16 L/mole of a 1 N solution of hydrochloric acid was added in small portions under stirring. The resulting precipitate was filtered off and washed several times with water, n-pentane, n-hexane, and diethylether. The precipitate was dried and could be used without further purifications. There was obtained a faint yellow solid at 94% yield.

### EXAMPLE 3

### Di-(5-(8-Phenyl-naphthyl)-thiazole)-iridium-(acetylacetonate)

Di-(5-(8-Phenyl-naphthyl)-thiazole)-iridium-(acetylacetonate) is a compound according to the invention, represented by formula IX wherein in the terms of general formula I, Ar3 is naphthyl, substituted in each positions 1 and 8 (the anchor-C-atoms) with one of U and V, which are chemical bonds, Ar2 is phenyl and Ar1 is thiazolyl having its bond (U) to the naphthyl in its 5′-position.

Derivatives of this compound can be obtained by formally exchanging the phenyl group for (hetero) aromatic groups comprising at least one aromatic ring as Ar3, which may be five- or six-membered ring. In accordance with the invention, groups Ar1 and Ar2 are linked to the anchor-C-atoms of the aromatic ring comprised in Ar3.

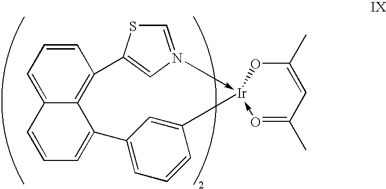

### EXAMPLE 4

### Tris-(4-oxazole-5-yl-5-phenyl-quinoline)-iridium

Tris-(4-oxazole-5-yl-5-phenyl-quinoline)-iridium is a compound according to the invention, represented by the following formula X wherein in the terms of general formula I, Ar3 is quinoline, substituted in positions 4 and 5 which are the anchor-C-atoms, with one of U and V, respectively, which are chemical bonds, wherein Ar2 is phenyl and Ar1 is oxazolyl. Ar1 is having its bond (U) to the quinoline in its 5′-position.

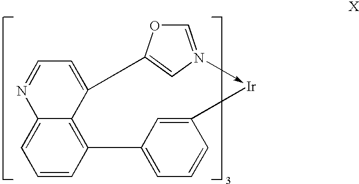

### EXAMPLE 5

### Tris-(4-(2-methyl-3-phenyl-benzo[b]thiophene-4-yl)-pyridine)-iridium

Tris-(4-(2-methyl-3-phenyl-benzo[b]thiophene-4-yl)-pyridine)-iridium is a compound according to the invention, represented by the following formula XI wherein in the terms of general formula I, Ar3 is 2-methyl-benzo[b]thiophene, substituted in positions 3 and 4 which are the anchor-C-atoms, with one of U and V, which are chemical bonds, wherein Ar2 is phenyl and Ar1 is pyridine. Ar1 is having its bond (U) to the 2-methyl-benzo[b]thiophene in its 4′-position.

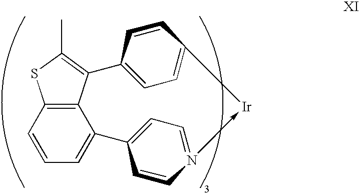

### EXAMPLE 6

### Bis-(3-(8-thiophene-2-yl-anthracene-1-yl)-pyridine)-palladium

Bis-(3-(8-thiophene-2-yl-anthiacene-1-yl)-pyridine)-palladium is a compound according to the invention, represented by the following formula XII is a compound wherein in the terms of general formula I, Ar3 is anthracene, substituted in positions 3 and 8, which are the anchor-C-atoms, with one of U and V, which are chemical bonds, wherein Ar2 is thiophene and Ar1 is pyridine. Ar1 is having its bond (U) to the anthracene in its 3′-position.

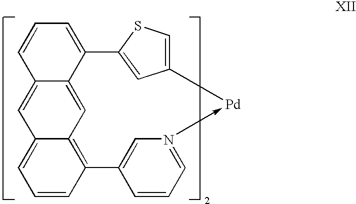

### EXAMPLE 7

### Bis-(3-(3,3-dimethyl-cyclopenta-1,4-dienyl)-5-phenyl-4-(4H-pyrrole-3-yl)-isoxazole)-platinum

Bis-(3-(3,3-dimethyl-cyclopenta-1,4-dienyl)-5-phenyl-4-(4H-pyrrole-3-yl)-isoxazole)-platinum is a compound according to the invention, represented by the following formula XIII, wherein in the terms of general formula I, Ar3 is 5-phenyl-isoxazole, substituted in positions 3 and 4, which are the anchor-C-atoms, with one of U and V, which are chemical bonds, wherein Ar2 is 3,3-dimethyl-cyclopenta-1,4-dienyl and Ar1 is 4H-pyrrole. Ar1 is having its bond (U) to the 5-phenyl-isoxazole in its 4′-position.

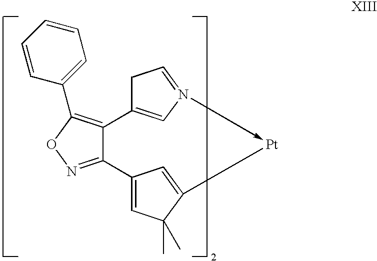

### EXAMPLE 8

### Di-(9-methyl-4-phenyl-5-thiazole-5-yl-9H-carbazole)-iridium-(acetylacetonate)

Di-(9-methyl-4-phenyl-5-thiazole-5-yl-9H-carbazole)-iridium-(acetylacetonate) is a compound according to the invention, represented by the following formula XIV wherein in the terms of general formula I, Ar3 is 9-methyl-9H-carbazole, substituted in positions 4 and 5, which are the anchor-C-atoms, with one of U and V, which are chemical bonds, wherein Ar2 is phenyl and Ar1 is thiazolyl. Ar1 is having its bond (U) to the anchor-C-atom in its 5′-position.

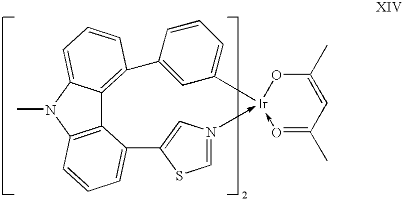

### EXAMPLE 9

### Electroluminescent Devices Comprising an Emitter Compound

Representatives for electroluminescent devices of the invention, comprising an emitter compound as described above, are schematically depicted in FIGS. 1 to 3. In these EL devices, the emitter compound is arranged between the outer electrode contacts adjacent charge transport layers to allow transport of holes and electrons, respectively to recombine to an exciton within the emitter compound. However, the emitter compound itself may contribute to or replace charge transport functions of adjacent layers when substituted with the respective charge transport moieties or, preferably, when embodied as an orthogonally oriented compound that the respective charge transport moieties on the second Ar3 group.

1. Compound suitable for forming a light emitting layer in electroluminescence device, characterized by comprising a core structure according to general formula I 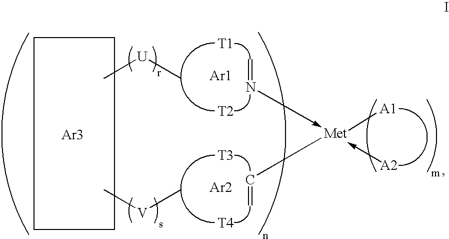
wherein Met is a metal atom selected from Ir, Pt, Pd, Ru, Rh, Re, or Os
with n=1-3, m=3-n for Ir, Ru, Rh, Re or Os and with n=1 or 2, m=2-n for Pt or Pd,
wherein r and s are independently positive natural numbers, preferably varying by a maximum of 2, more preferably identical,
wherein groups U and V can be selected independently from a chemical bond, any substituted or unsubstituted aromatic or non-aromatic poly- or mono-cyclic group, alkyl, a double bond, a triple bond, nitrogen, oxygen, sulfur, selenium, telluride, NR
with R selected from hydrogen, alkyl, aryl or heteroaryl,
wherein Ar1 and Ar2 are independently π-electron containing systems,
wherein Ar3 contains anchor-C-atoms for linkage of groups U and V, respectively,
and Ar3 is an aromatic or non-aromatic moiety, and
wherein 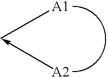
is a saturating monoanionic ligand.

2. Compound according to claim 1 or 2, characterized by T1, T2, T3 and T4 independently selected from —O—, —S—, —NR—, —CRR′—, ═CR—, ═N—, —N═N—, ═N—O—, —O—N═, —NR—O—, —O—NR—, ═N—S—, —S—N═, —NR—S—, —S—NR—, —N═CR—, —CR═N—, —NR—CR′R″—, —CR′R″—NR—, ═N—CRR′—, CRR′—N═, —CR═CR′—, with R and R′ and R″ independently selected from hydrogen, (hetero)alkyl, and (hetero)aryl.

3. Compound according to claim 1 or 2, characterized by Ar3 being represented by formula II: 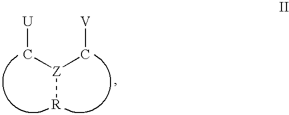
wherein Z is a chemical bond directly linking the two anchor-C-atoms and substituent R completes Ar3 to an aromatic or non-aromatic moiety comprising a five-, six- or seven-membered ring.

4. Compound according to claim 1 or 2, characterized by Ar3 being represented by formula IIIa: 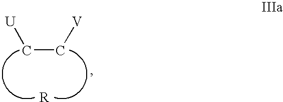
wherein, R is a moiety completing Ar3 to a five-, six- or seven-membered ring, preferably aromatic, optionally containing hetero atoms, comprising the two anchor-C-atoms.

5. Compound according to claim 1 or 2, characterized by Ar3 being represented by formula 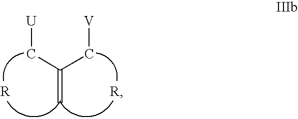
wherein Z is a carbon atom arranged between the two anchor-C-atoms and R is a moiety completing Ar3 to a moiety comprising two rings, preferably two anellated five- and/or six-membered aromatic rings.

6. Compound according to claim 1 or 2, characterized by Ar3 being represented by formula IIIc: 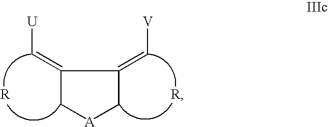
wherein Z comprises two carbon atoms, group R complements Z and the two anchor-C-atoms to a ring system, wherein each of the two anchor-C-atoms is comprised within a five- or six-membered aromatic ring, and wherein substituent A may represents a chemical bond, an atom or a group to arrange 1, 2 or 3 atoms or groups into a four-, five-, six- or seven-membered ring.

7. Compound according to claim 6, characterized by Ar3 being represented by one of the following formulae:

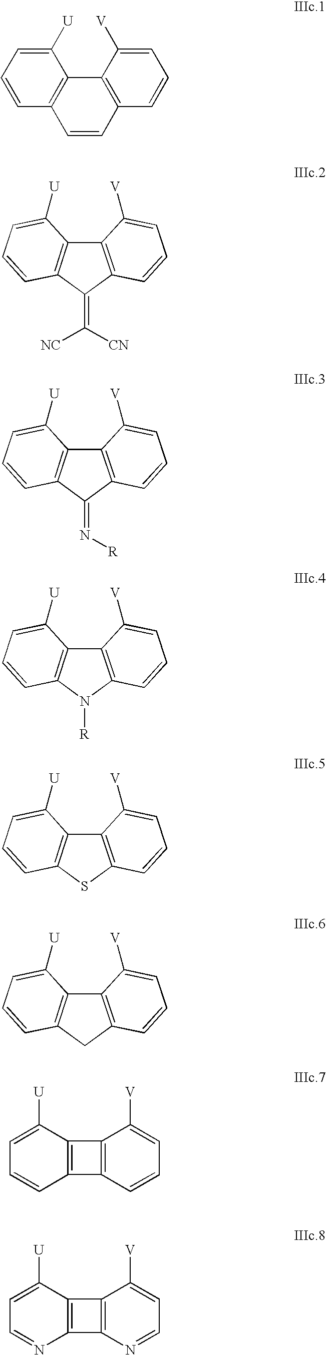

8. Compound according to claim 1 or 2, characterized by Ar3 being represented by formula IIId:

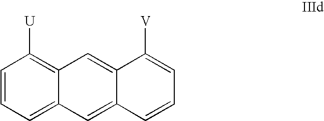

9. Compound according to claim 1 or 2, characterized by Ar3 being selected from phenyl, pyridine, pyrimidine, imidazole, oxazole, oxadiazole, thiadiazole, pyrazine, pyridazine, triazine, triazole, tetrazole, indazole, triazole, quinoline, isoquinoline, quinoxaline, phthalazine, quinazoline, naphtholidine, cinnoline, phenanthroline, pyrazole, benzimidazole, benzoxazole, benzthiazole, phenazine, pteridine, purine, phenoxazine, phenothiazine, benzo[g]pteridine, indole, phenanthridine, phenanthrene, chrysene, acenaphthylene, pyrene, coronene, benzo(a)pyrene, naphthopyrene, fluorene, carbazole, naphthalene, anthrene, benzamidazole, benzothiophene, and heteroatom substituted homologs thereof.

10. Compound according to one of the preceding claims, characterized by Ar3 being linked as a first Ar3 to a tetraedric central atom (ZA), which central atom is further linked to a second group Ar3, substituted with both groups U, V and groups Ar1, Ar2, respectively, independently from the first Ar3, according to formula 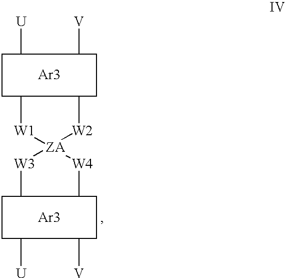
wherein W1, W2, W3, W4 can be selected from a chemical bond and at least divalent atoms and groups, and wherein ZA is C, Si or Ge.

11. Compound according to claim 10, characterized in that the divalent atoms or groups are independently selected from the group consisting of —S—, —NR—, —O—, —CH₂—, a carbonyl group, —SO₂—, di-substituted silicon, and —CRR′—, with R and R′ any (hetero)alkyl or (hetero)aryl or hydrogen.

12. Compound according to claim 10, characterized by the first Ar3 and the second Ar3 being identical.

13. Compound according to one of claims 1 to 9, characterized in that Ar3 is naphthyl according to the following formula V:

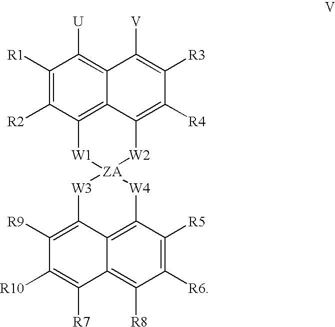

14. Compound according to claim 13, characterized in that R7 and R8 are groups U′ and V′, selected independently from moieties forming groups U and V, also substituted with Ar1 and Ar2, respectively, being linked to a second metal atom (Met).

15. Compound according to one of claims 1 to 9, characterized in that Ar3 is biphenyl according to the following formula VI:

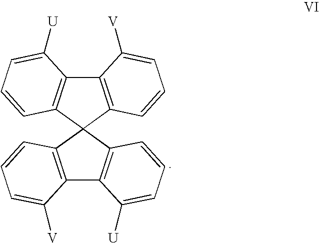

16. Compound according to one of claims 10 to 15, characterized by the second Ar3 being substituted with electron transporting moieties, hole transporting moieties and/or emitter moieties.

17. Compound according to one of claims 10 to 16, characterized by at least two moieties according to formulae IV to VI forming an oligomer or a polymer, complexing between them a metal atom.

18. Compound according to one of the preceding claims, characterized by Ar1 being selected from the group comprising five- or six-membered heteroaryl rings, containing at least one nitrogen atom, pyridine, pyrimidine, pyrazine, pyridazine, triazine, tetrazole, indazole, imidazole, triazole, or
Ar1 forming part of a fused ring system comprised in the group of quinoline, isochinoline, quinoxaline, phthalazine, quinazoline, naphtholidine, cinnoline, phenanthroline, imidazole, benzimidazole, benzoxazole, benzthiazole, phenazine, pteridine, purine, phenoxazine, phenothiazine, benzo[g]pteridine, indazolyl, indolyl, and phenanthridine.

19. Compound according to one of the preceding claims, characterized by Ar2 being selected from the group comprising five- or six-membered aryl or heteroaryl rings, phenyl, pyridyl, pyrimidinyl, pyrazinyl, imidazolyl, pyrazolinyl, oxazolinyl, oxadiazolinyl, triazolyl, triazinyl, thiadiazolyl, furyl and thienyl or Ar2 forming part of a fused ring system comprised in the group of naphthyl, anthryl, phenanthryl, benzamidazolyl, carbazolyl, fluorenyl, pyridanzinyl, quinolinyl, isoquinolinyl, quinoxalinyl, benzothiophenyl, phthalazinyl, quinazolinyl, benzimidazolyl, benzoxazolyl, and phenanthridinyl.

20. Compound according to one of the preceding claims, characterized by Ar1 and/or Ar2 being substituted by one or more substituents comprised in the group of halogen atoms, alkyl (comprising one to fifteen carbon atoms), haloalkyl, CF₃, CF₂CF₃, alkyloxy, aryloxyaryl, allyloxyaryl, aryl, alkylaryl, cyano, amino, dialkylamino, diarylamino, alkylthio, arylthio, sulfinyl, sulfonyl, aryloxy, alkylarylamino, benzylic alcohol and aldehyde.

21. Compound according to one of the preceding claims, characterized by U and V being selected independently from the group comprising phenyl, naphthyl, thienyl, pyrrolyl, oxazolyl, and anthracene or phenanthrene, wherein r and s are independently 0 to 8.

22. Compound according to one of the preceding claims, characterized by substituents to Ar3 being selected from the group comprising (hetero) alkyl, (hetero) aryl, hydrocarbon moieties forming an anellated or condensed ring to Ar3, hole transport moieties and electron transport moieties.

23. Process for producing a compound according to one of the preceding claims.

24. Process according to claim 23, characterized by presence of an intermediate k-halogen-complex, wherein the halogen is chlorine or bromine.

25. Process for producing an electrooptic device, characterized by use of a compound according to one of claims 1 to 22.

26. Process according to claim 25, characterized in that organic layers and the final contacting electrode of the device are formed under vacuum.

27. Process according to claim 26, characterized in that the vacuum process is a PVD (physical vapour deposition), CVC (chemical vapour deposition), or an OVPD (organic vapour physical deposition) process.

28. Process according to claim 25, characterized in that the compound according to one of claims 1 to 22 is applied by coating from solution or sputtering.

29. Process according to claim 28, characterized in that the coating is spray, spin, dip or knife coating.

30. Electrooptical device, characterized by comprising a compound according to claims 1 to 22.

31. Electrooptical device according to claim 30, characterized in that the electrooptical device is and OLED, OFET, laser or photovoltaic device.
